(19) United States
(12) Patent Application Publication
(10) Pub. No.: US 2015/0009496 A1
(43) Pub. Date: Jan. 8, 2015

(54) ELEMENTAL ANALYSIS DEVICE IN LIQUID

(71) Applicant: PANASONIC CORPORATION, Osaka (JP)

(72) Inventors: Hironori KUMAGAI, Osaka (JP); Shin-ichi IMAI, Osaka (JP)

(21) Appl. No.: 14/500,369

(22) Filed: Sep. 29, 2014

Related U.S. Application Data
(63) Continuation of application No. PCT/JP2014/000323, filed on Jan. 23, 2014.

(30) Foreign Application Priority Data
Jan. 28, 2013 (JP) 2013-013565

(51) Int. Cl. G01N 21/67

(52) U.S. Cl. CPC G01N 21/67; G01N 2201/06113; G01N 2201/067; G01N 2201/08
USPC 356/316

(57) ABSTRACT

An elemental analysis device that analyzes an element in a liquid with high sensitivity and with a simple configuration is provided. The elemental analysis device of the present disclosure disposes a part of a first electrode disposed around an insulator having an opening portion, and a part of a second electrode. The elemental analysis device applies a voltage by use of a power supply disposed between the first electrode and the second electrode. The elemental analysis device analyzes the element in the liquid so that a light detection device detects an emission spectrum generated by interaction of plasma generated by applying the voltage with the element in the liquid.

### CROSS-REFERENCE

This is a continuation application of International Application No. PCT/JP2014/000323, with an international filing date of Jan. 23, 2014, which claims priority of Japanese Patent Application No. 2013-013565 filed on Jan. 28, 2013, the content of which is incorporated herein by reference.

### DESCRIPTION OF THE RELATED ART

The present disclosure relates to an elemental analysis device which analyzes an element in a liquid by generating plasma in the liquid.

The conventional elemental analysis devices using plasma are disclosed in Patent Literature 1 (WO2005/093394), Patent Literature 2 (Japanese Patent Laid-open Publication No. H09-26394A), and Patent Literature 3 (Japanese Patent Laid-open Publication No. 2002-372495A). All these Patent Literatures disclose a method which analyzes an element by detecting a light emission derived from the element generated by plasma.

The conventional plasma generation device has a narrow portion at a microfabricated flow path, more specifically, the flow path formed by an insulating material (refer to Patent Literature 1, for example). The narrow portion has a cross-section area which is significantly smaller than a cross-sectional area of the microfabricated flow path. The conventional plasma generation device applies a voltage in the flow path to generate plasma. Another conventional device which generates plasma by discharging on water is disclosed (refer to Patent Literature 2, for example). In addition, the conventional device which generates plasma by a laser irradiation is disclosed (refer to Patent Literature 3, for example).

### SUMMARY

However, the device of Patent Literature 1 described above has a problem that it is necessary to prepare a specially processed cell separately so as to generate plasma by use of the specially processed cell. In addition, Patent Literature 1 discloses that adjusting an electric conductivity of a liquid solution having low electric conductivity is preferable. The device of Patent Literature 1 has a problem that a measurement setup for adjusting the electric conductivity of the liquid solution is complicated. The measurement device of Patent Literature 2 is capable of generating plasma relatively easily by discharging on water. However, plasma emits light in the atmosphere mainly. The light emission of the plasma is relatively small because an interaction of the plasma with a liquid is limited to plasma contacting portion. Therefore, the measurement device of Patent Literature 2 has a problem that it is difficult to obtain a sensitivity required for an elemental analysis. An analysis device of Patent Literature 3 has a problem that a device configuration is complex because the analysis device requires a laser for generating plasma separately.

One non-limiting and exemplary embodiment provides an elemental analysis device in a liquid which is capable of a high sensitivity elemental analysis with a simple configuration.

In one general aspect, an elemental analysis device according to the present disclosure includes:

a first electrode having a part disposed in a treatment tank into which a liquid is filled;

a second electrode having a part disposed in the treatment tank;

an insulator disposed around the first electrode, wherein the insulator has an opening portion which is arranged to expose the part of the first electrode;

a power supply that applies a voltage between the first electrode and the second electrode; and

a light detection device that detects an emission spectrum of plasma which is generated by applying the voltage by use of the power supply so as to discharge near the opening portion;

wherein an element included in the liquid is analyzed based on the emission spectrum which is detected by the light detection device.

The elemental analysis device according to the present disclosure is capable of a high sensitivity elemental analysis with a simple configuration.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 shows an overall block diagram of an elemental analysis device according to a first embodiment of the present disclosure.

FIG. 2 shows an opening portion of an insulator according to the first embodiment of the present disclosure.

FIG. 3 shows a relationship between a diameter of the opening portion and a stability of discharge according to the first embodiment of the present disclosure.

FIG. 4 shows a view of comparing an emission spectrum of Example 1 with an emission spectrum of Comparative Example 1 at electric conductivity of about 50 mS/m.

FIG. 5 shows a view of comparing Na/H of Example 1 with Na/H of Comparative Example 1 in the case of electric conductivity in ranging from 0 to 300 mS/m.

FIG. 6 shows a view of comparing an emission spectrum of Example 2 with an emission spectrum of Comparative Example 2 in commercial mineral water.

FIG. 7 shows an overall block diagram of an elemental analysis device according to a second embodiment of the present disclosure.

FIG. 8 shows a view of a usage example of the elemental analysis device according to the second embodiment of the present disclosure.

FIG. 9 shows an overall block diagram of a variation of the elemental analysis device according to the second embodiment of the present disclosure.

FIG. 10 shows an overall block diagram of another variation of the elemental analysis device according to the second embodiment of the present disclosure.

FIG. 11 shows a block diagram of a reference example of an elemental analysis device.

### DETAILED DESCRIPTION

An elemental analysis device according to a first aspect of the present disclosure includes:

a first electrode having a part disposed in a treatment tank into which a liquid is filled;

a second electrode having a part disposed in the treatment tank;

an insulator disposed around the first electrode, wherein the insulator has an opening portion which is arranged to expose the part of the first electrode;

a power supply that applies a voltage between the first electrode and the second electrode; and

a light detection device that detects an emission spectrum of plasma which is generated by applying the voltage by use of the power supply so as to discharge near the opening portion;

wherein an element included in the liquid is analyzed based on the emission spectrum which is detected by the light detection device.

With this structure, the elemental analysis device of the present disclosure may generate plasma with a simple configuration as compared with a conventional device. In addition, the elemental analysis device of the present disclosure may detect plasma light with high sensitivity because the plasma is easy to contact with an element in a liquid as compared with the conventional device. Moreover, the elemental analysis device of the present disclosure may analyze the element without doing a pretreatment for adjusting an electric conductivity of the liquid as in the conventional device.

In an elemental analysis device according to a second aspect of the present disclosure, the elemental analysis device in the first aspect further includes a treatment tank in which the first and the second electrodes are disposed,

wherein at least a part of the treatment tank is optically transparent.

With this structure, the light detection device disposed out of the treatment tank may detect efficiently the plasma light which is generated at the opening portion.

In an elemental analysis device according to a third aspect of the present disclosure, the opening portion in the first aspect has a diameter of less than or equal to 1 mm.

With this structure, the elemental analysis device of the present disclosure may discharge surely and stably by concentrating an electric field near the opening portion of the insulator when the power supply applies the voltage between the first electrode and the second electrode.

In an elemental analysis device according to a fourth aspect of the present disclosure, the light detection device in the first aspect detects plasma light spreading to the liquid side of the plasma which is generated near the opening portion.

With this structure, the elemental analysis device of the present disclosure may detect the plasma light where the interaction of the liquid with the plasma particularly is strong, and may improve detection sensitivity.

In an elemental analysis device according to a fifth aspect of the present disclosure, the insulator in the first aspect is optically transparent.

With this structure, the optically transparent insulator may prevent the elemental analysis device of the present disclosure from absorbing the plasma light, and the elemental analysis device of the present disclosure may detect the plasma light efficiently.

In an elemental analysis device according to a sixth aspect of the present disclosure, the insulator in the fifth aspect includes quartz.

With this structure, the insulator including quartz may prevent the elemental analysis device of the present disclosure from absorbing a light especially in the ultraviolet region. In addition, there may be provided the elemental analysis device having high resistance to plasma.

In an elemental analysis device according to a seventh aspect of the present disclosure, the first electrode in the first aspect is made of tungsten.

With this structure, the elemental analysis device of the present disclosure may improve detection sensitivity of the plasma light from an element in the liquid because a light emission from the first electrode may be suppressed or reduced.

In an elemental analysis device according to an eighth aspect of the present disclosure, the power supply in the first aspect applies a pulse voltage having a peak voltage of more than or equal to 4 kV.

With this structure, the elemental analysis device of the present disclosure may discharge surely and generate plasma light efficiently, by concentrating an electric field near the opening portion of the insulator.

In an elemental analysis device according to a ninth aspect of the present disclosure, the elemental analysis device includes:

a first electrode;

a second electrode;

an insulator disposed around the first electrode, wherein the insulator has an opening portion which is arranged to expose a part of the first electrode;

a power supply that applies a voltage between the first electrode and the second electrode; and

a light detection device that detects an emission spectrum of plasma which is generated by applying the voltage by use of the power supply so as to discharge near the opening portion;

wherein a module is formed by the first electrode, the second electrode, and the insulator,

the module is disposed in a liquid,

plasma is generated near the opening portion by applying the voltage between the first electrode and the second electrode by use of the power supply, and an element included in the liquid is analyzed based on the emission spectrum of the plasma which is detected by the light detection device.

With this structure, the elemental analysis device having good portability may be provided. For example, by immersing the module into the liquid which is analyzed, at least a part of the first electrode and at least a part of the second electrode may be immersed in the liquid. Therefore, the elemental analysis device may analyze an element easily and with high sensitivity anytime and anywhere.

In an elemental analysis device according to a tenth aspect of the present disclosure, the module in the ninth aspect further includes the power supply.

With this structure, the elemental analysis device with good portability may be provided. In addition, there may be provided the elemental analysis device having better handleability because the module includes the power supply.

In an elemental analysis device according to an eleventh aspect of the present disclosure, the module in the ninth aspect further includes the light detection device.

With this structure, the elemental analysis device with good portability may be provided. In addition, there may be provided the elemental analysis device having better handleability because the module includes the light detection device.

In an elemental analysis device according to a twelfth aspect of the present disclosure, the module in the ninth aspect is waterproofed.

With this structure, by immersing the module into the liquid, at least a part of the first electrode and at least a part of the second electrode may be immersed in the liquid so as to analyze an element easily and with high sensitivity. In addition, the elemental analysis device of the present disclosure may perform the elemental analysis multiple times by moving the module in the liquid so as to change location or depth which plasma is generated. Therefore, for example, the elemental analysis device may perform a mapping of impurities and the like easily.

In an elemental analysis device according to a thirteenth aspect of the present disclosure, the opening portion in the ninth aspect has a diameter of less than or equal to 1 mm.

With this structure, the elemental analysis device of the present disclosure may discharge surely and stably by concentrating an electric field near the opening portion of the insulator when the power supply applies the voltage between the first electrode and the second electrode.

In an elemental analysis device according to a fourteenth aspect of the present disclosure, the light detection device in the ninth aspect detects plasma light spreading to the liquid side of the plasma which is generated near the opening portion.

With this structure, the elemental analysis device of the present disclosure may detect the plasma light where the interaction of the liquid with the plasma particularly is strong, and may improve detection sensitivity.

In an elemental analysis device according to a fifteenth aspect of the present disclosure, the insulator in the ninth aspect is optically transparent.

With this structure, the optically transparent insulator may prevent the elemental analysis device of the present disclosure from absorbing the plasma light, and the elemental analysis device of the present disclosure may detect the plasma light efficiently.

In an elemental analysis device according to a sixteenth aspect of the present disclosure, the insulator in the fifteenth aspect includes quartz.

With this structure, the insulator including quartz may prevent the elemental analysis device of the present disclosure from absorbing a light especially in the ultraviolet region. In addition, there may be provided the elemental analysis device having high resistance to plasma.

In an elemental analysis device according to a seventeenth aspect of the present disclosure, the first electrode in the ninth aspect is made of tungsten.

With this structure, the elemental analysis device of the present disclosure may improve detection sensitivity of the plasma light from an element in the liquid because a light emission from the first electrode may be suppressed or reduced.

In an elemental analysis device according to an eighteenth aspect of the present disclosure, the power supply in the ninth aspect applies a pulse voltage having a peak voltage of more than or equal to 4 kV.

With this structure, the elemental analysis device of the present disclosure may discharge surely and generate plasma light efficiently, by concentrating an electric field near the opening portion of the insulator.

### Circumstances Leading to One Embodiment According to the Present Disclosure

In the Patent Literatures 1 to 3 as described in the above “Description of The Related Art”, there has a problem that the device configuration for generating plasma is complex. In addition, when the electric conductivity of a liquid is low, there has a problem that it is difficult to obtain necessary sensitivity for analyzing an element without doing a pretreatment, such as increasing an electric conductivity of the liquid.

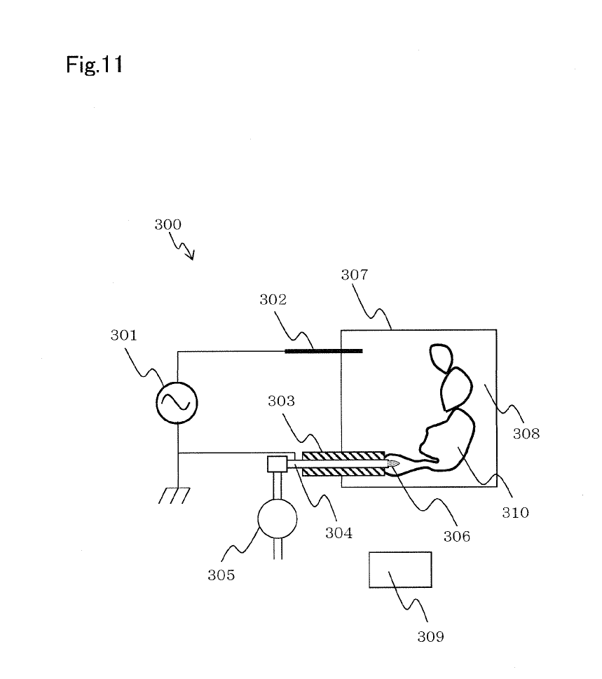

As an elemental analysis device of another reference example, there is the elemental analysis device as shown in FIG. 11. FIG. 11 shows an overall block diagram of an elemental analysis device 300 of the reference example. The elemental analysis device 300 of the reference example includes a treatment tank 307, a first electrode 304, a second electrode 302, an insulator 303, a power supply 301, a gas supply device (a pump) 305, and a light detection device 309. At least a part of the first electrode 304 and at least a part of the second electrode 302 are disposed in the treatment tank 307 into which a liquid is filled. The circumference surface of the first electrode 304 is covered with the insulator 303. Bubble 310 is formed in a liquid 308 by supplying a gas from the pump 305 to an opening portion of the first electrode 304. The power supply 301 applies a voltage between the first electrode 304 and the second electrode 302, and generates plasma 306 in the bubble 310. The light detection device 309 detects plasma light which is generated by an interaction of the plasma 306 with an element in the liquid 308. The present inventors find the following problems with respect to the elemental analysis device 300 of the above reference sample by the earnest research.

The elemental analysis device 300 of the reference example supplies the gas (such as air) from the pump 305 into the liquid 308 so as to generate the bubble 310, and discharges in the bubble 310. As the result of this, the elemental analysis device 300 improves a generation efficiency of the plasma 306. However, there has a problem that it is difficult to obtain a necessary sensitivity for analyzing an element when the liquid has low electric conductivity, because the air supplied from the pump 305 interferes with contact of the element in the liquid 308 with the plasma 306. In addition, the conventional elemental analysis device 300 has a problem that a discharge frequency is reduced when the gas is not supplied in the liquid 308 by use of the pump 305, and cannot generate stably the plasma 306 in the bubble 310 in the liquid 308. That is, there has the problem that the device configuration of the reference example cannot generate stably the plasma 306 without the pump 305.

In order to solve the above problems, the present inventors find a configuration which is able to generate plasma stably and efficiently without the gas supply device, by devising to design a diameter of the opening portion arranged at the insulator so as to discharge stably.

Hereinafter, embodiments of the present disclosure will be described with reference to the drawings. Note, in all figures below, the same or corresponding portions will be denoted by the same symbols, without redundant description.

### First Embodiment

In a first embodiment of the present disclosure, there is explained a fundamental aspect which generates plasma in a liquid and analyzes an element.

### [Overall Configuration]

A configuration of an elemental analysis device 100 according to the first embodiment is explained.

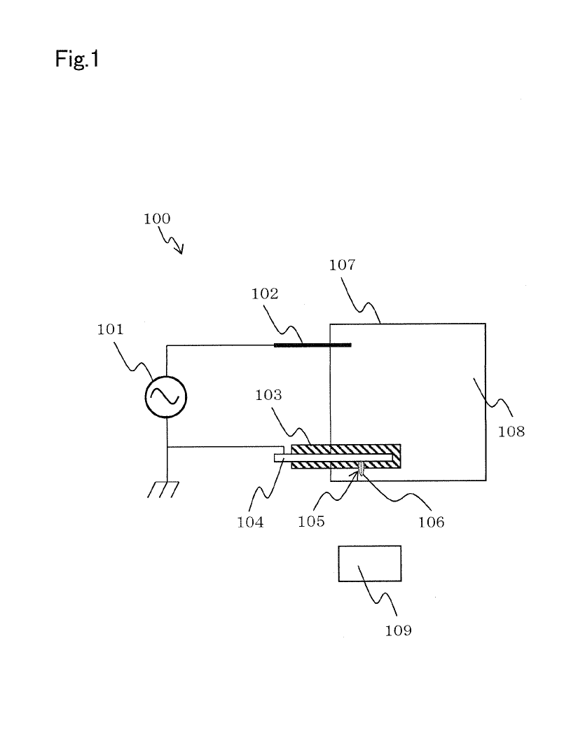

FIG. 1 shows an overall block diagram of the elemental analysis device 100 according to the first embodiment of the present disclosure. As shown in FIG. 1, the elemental analysis device 100 includes a first electrode 104, a second electrode 102, an insulator 103, a power supply 101, and a light detection device 109. The elemental analysis device 100 further includes a treatment tank 107. The treatment tank 107 may be not an essential component.

### <First Electrode>

At least a part of the first electrode 104 is disposed in the treatment tank 107 into which a liquid 108 is filled. The first electrode 104 may be not limited in particular and may be made of any metal or alloy. For example, the first electrode 104 may be made of iron, tungsten, copper, aluminum, platinum, or an alloy containing one or more metals selected from these metals and the like. Especially, tungsten and platinum having a high melting point are stable metals. Therefore, if the first electrode 104 is made of tungsten, platinum, or an alloy containing one or more metals selected from these metals, the first electrode 104 may suppress or reduce influence of the spectrum derived from the electrode.

### <Second Electrode>

At least a part of the second electrode 102 also is disposed in the treatment tank 107 into which the liquid 108 is filled. In similar to the first electrode 104, the second electrode 102 may be made of iron, tungsten, copper, aluminum, platinum, or an alloy containing one or more metals selected from these metals and the like. A distance between the first electrode 104 and the second electrode 102 is not limited in particular, and may be set optionally.

### <Insulator>

The insulator 102 is formed around the circumference of the first electrode 104. The insulator 103 may be made of aluminum oxide, magnesium oxide, yttrium oxide, insulating plastic, glass, and quartz and the like. For example, the insulator 103 may be optically transparent to a light in the wavelength region to be detected by the light detection device 109. It is possible to suppress plasma light from being absorbed by insulator 103 and detect efficiently the plasma light which is generated near the opening portion 105 of the insulator 103 by use of the light detection device 109 because the insulator 103 is transparent. The transparent insulator 103 is such as quartz, but it is not limited thereto, and other materials may be used. The insulator 103 may be not transparent if the plasma light can be detected efficiently at the side of the light detection device 109.

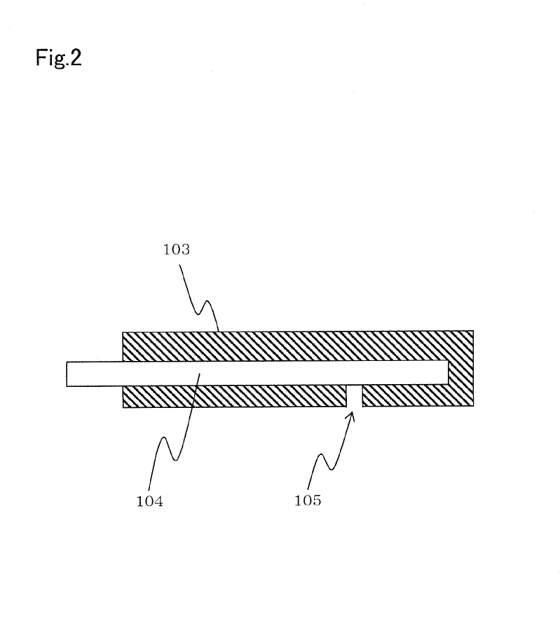

FIG. 2 shows the opening portion 105 of the insulator 103 according to the first embodiment. As shown in FIG. 2, in the insulator 103, the opening portion 105 is arranged such that a part of the first electrode 104 is exposed to the liquid. In FIG. 1 and FIG. 2, the opening portion 105 is arranged toward the direction of gravitational force (toward the direction of the bottom surface side of the treatment tank 107 as shown in FIG. 1) at the side surface of the insulator 103. But, the opening portion 105 is not limited to it, and may be arranged at any position in range which the light detection device 109 can detect the plasma light. For example, the opening portion 105 according to the first embodiment may be arranged toward the opposite direction of gravitational force (toward the direction of the upper surface side of the treatment tank 107 as shown in FIG. 1) at the side surface of the insulator 103. Such arrangement of the opening portion 105 may suppress bubble clogging, and may prevent the reduction of plasma generation efficiency. The shape of the opening portion 105 may have any shape, such as rectangular or circular shapes and the like. The opening portion 105 according to the first embodiment has a circular shape.

### <Power Supply>

The power supply 101 is disposed between the first electrode 104 and the second electrode 102. In the first embodiment, a pulse power supply is used as the power supply 101, and applies a voltage between the first electrode 104 and the second electrode 102. For example, the pulse power supply applies a pulse voltage having a peak voltage of more than equal to 4 kV so as to discharge surely near the opening portion 105. In the first embodiment, the power supply 101 is the pulse power supply, but may not be limited to it. The power supply 101 may be AC power source or DC power source in range which the plasma can be generated in bubble in the liquid 108 near the opening portion 105.

### <Light Detection Device>

The light detection device 109 detects the plasma light which is generated near the opening portion 105. The light detection device 109 is disposed out of the treatment tank 107. In FIG. 1, the light detection device 109 is disposed at the bottom side of the treatment tank 107, but is not limited to there. The light detection device 109 may be disposed at any position. In the first embodiment, the plasma is generated and is spreaded from the first electrode 104 to the liquid 108 at the opening portion 105. That is, at the opening portion 105, the plasma 106 is generated from a part of the first electrode 104 which is exposed to the liquid 108 toward a direction which the opening portion 105 is opened. The light detection device 109 may be disposed so as to detect only the plasma light spreading to the liquid 108 (hereinafter referred to as “the plasma light at the liquid 108”) except for the plasma generating at the first electrode 104. For example, the insulator 103 may be made of a material which cuts off the plasma light, and the light detection device 109 may be disposed in a direction perpendicular to the direction which the opening portion 105 is opened. When explained with FIG. 1, the light detection device 109 may be disposed at the side surface of the treatment tank 107 (for example, the front of the treatment tank 107 in FIG. 1) so as to detect only the plasma light at the liquid 108. For example, the light detection device 109 may include a combination of PD (Photodiode) and a spectroscope. PD is used to detect an intensity of light. For example, PD may be CCD (Charge Coupled Device) or CMOS (Complementary Metal Oxide Semiconductor) sensor and the like. For example, the spectroscope may be a diffraction grating, a prism, or a filter and the like. In addition, PMT (Photomultiplier Tube) may be used instead of PD. The light detection device 109 may be configured to combine PMT and the spectroscope.

### <Treatment Tank>

The treatment tank 107 is filled with the liquid 108. The treatment tank 107 may be optically transparent. Because the treatment tank 107 is transparent, it is possible to detect the plasma light which is generated in the bubble in the liquid 108. The entire treatment tank 107 need not be optically transparent. A part of the treatment tank 107 may be transparent in a light path extended from the generation position of the plasma light to the light detection device 109. That is, the entire treatment tank 107 may be not transparent, and the part of the treatment tank 107 may be transparent such that the light detection device can detect the emission spectrum of the plasma 106.

### [Operation]

Next, an operation of the elemental analysis device 100 according to the first embodiment is explained.

In the elemental analysis device 100 according to the first embodiment, the power supply 101 applies the voltage between the first electrode 104 and the second electrode 102. By applying the voltage between the first electrode 104 and the second electrode 102, an electric field concentration is generated near the opening portion 105 arranged at the insulator 103. As a result of the electric field concentration, the liquid 108 is boiled and the bubble is generated, and then the plasma 106 is generated by discharging in the bubble. The light emission derived from an element (the plasma light) is generated by contacting the element in the liquid 108 with the plasma 106. The element in the liquid 108 may be analyzed by detecting the emission spectrum by use of the light detection device 109.

### [Effect (Discharge)]

An effect (discharge) of the elemental analysis device 100 according to the first embodiment is explained.

In the elemental analysis device 100 according to the first embodiment, an experiment has been performed to confirm whether or not the discharge is generated in the case of changing a diameter of the opening portion 105. Table 1 shows a relationship between the diameter of the opening portion and a presence or absence of discharge below.

TABLE 1

| | diameter of opening | | | | |
|---|---|---|---|---|---|
| | portion (mm) | | | | |
| | 0.3 | 0.5 | 0.7 | 1 | 2 |
| presence or | ◯ | ◯ | ◯ | ◯ | Δ |
| absence of | | | | | |
| discharge | | | | | |

As shown in FIG. 1, when the diameter of the opening portion is less than or equal to 1 mm, it has confirmed that the discharge generates (◯ as shown in Table 1). On the other hand, when the diameter of the opening portion is 2 mm, it has confirmed that the discharge frequency is reduced (Δ as shown in Table 1). Therefore, in the elemental analysis device 100 according to the first embodiment, it is preferable to set the diameter of the opening portion 105 to less than or equal to 1 mm so as to discharge surely by concentrating the electric field near the opening portion 105.

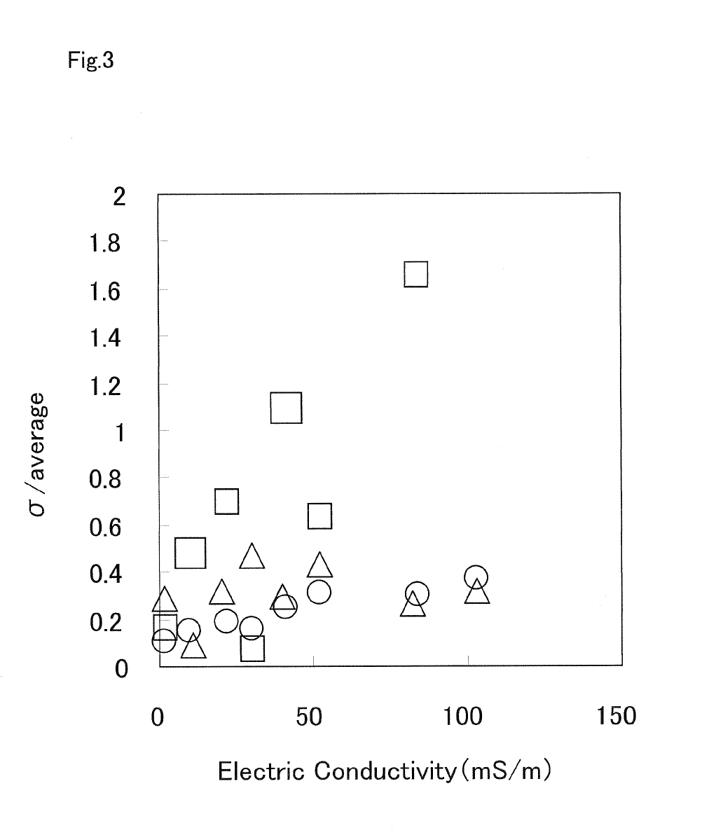

Next, in the elemental analysis device 100 according to the first embodiment, a stability evaluation of discharge has performed in the case of changing the diameter of the opening portion 105. FIG. 3 shows a relationship between the diameter of the opening portion 105 and a stability of discharge. In FIG. 3, a white circle (◯) indicates the diameter of 0.3 mm of the opening portion 105, a white triangle (Δ) indicates the diameter of 0.5 mm, a white square (□) indicates the diameter of 1.0 mm. In FIG. 3, a vertical axis is σ/average, and a horizontal axis is electric conductivity. The stability evaluation of discharge gets the spectrum per 2 seconds, and calculates average value (average) of about 10 spectra. In addition, the stability evaluation of discharge calculates a standard deviation (σ). A value of σ/average is derived by dividing the standard deviation (σ) of the spectrum by the average value (average). The stability evaluation of the discharge has performed by evaluating the value of σ/average with respect to each electric conductivity. The value of σ/average is a value which indicates a stability of the spectrum. The value of σ/average shows that the smaller this value is, the more stable the spectrum is.

As shown in FIG. 3, in the case that the diameter of the opening portion 105 is 1 mm (white square (□) in FIG. 3), the value of σ/average is stable at a low value while the value of σ/average increases slightly according to increased electric conductivity. As a result of this, in the case that the diameter of the opening portion 105 is less than or equal to 0.5 mm, it is found that the spectrum is stable at each electric conductivity. That is, it is found that the smaller the diameter of the opening portion 105 is, the more stable the discharge is. Therefore, in order to stabilize the discharge, the diameter of the opening portion 105 is preferably less than or equal to 0.5 mm.

From the above, in order to discharge certainly, the diameter of the opening portion 105 according to the first embodiment is preferably less than or equal to 1 mm, more preferably in ranging from 0.3 to 0.5 mm. By setting the diameter of the opening portion 105 in ranging from 0.3 to 0.5 mm, the discharge is generated stably. That is, if the diameter of the opening portion 105 according to the first embodiment is less than or equal to 1 mm, more preferably in ranging from 0.3 to 0.5 mm, the plasma 106 is generated stably and it is possible to realize the stable sensing. The diameter of 0.3 mm of lower limit value is process limitation in the case of using a low-cost processing method. It is possible to generate the stable discharge by setting in the above range by use of a low-cost device.

### [Effect (Detection Sensitivity)]

An effect (detection sensitivity) of the elemental analysis device according to the first embodiment is explained.

Hereinafter, in the elemental analysis device 100 according to the first embodiment (Example 1) and an elemental analysis device 300 according to a reference example (Comparative Example 1), there is explained about a comparative result which the elemental analysis is performed.

### Example 1

The detail configuration of Example 1 is described. In Example 1, the treatment tank 107 has a volume of about 100 cm³. The treatment tank 107 is made of glass. The first electrode 104 has a cylinder shape having a diameter of 1 mm. The first electrode 104 is made of tungsten. The insulator 103 has a cylindrical shape having an inner diameter of 3 mm and an outer diameter of 5 mm. The insulator 103 is made of quartz. The opening portion 105 of the insulator 103 has a circular shape having a diameter of 0.3 mm. The second electrode 102 has a cylinder shape having a diameter of 1 mm. The second electrode 102 is made of tungsten. A distance between the first electrode 104 and the second electrode 102 is about 40 mm. The liquid 108 is produced by dissolving NaCl in pure water. The electrical conductivity is adjusted in ranging from 2 mS/m to 100 mS/m. The power supply 101 supplies an electric power of 30 W, and applies a pulse voltage having a peak voltage of 4 kV, a pulse width of 1 μs, a frequency of 30 kHz to the first electrode 104. The light detection device 109 detects a light having a wavelength in ranging from 300 to 800 nm by use of a commercially available spectroscope. An exposure time is 20 ms. An accompanying optical fiber is attached to the spectroscope, and the optical fiber is disposed at a position which is able to detect the plasma light at the outside of the treatment tank 107.

In Example 1 having the above configuration, the elemental analysis device 100 applies the pulse voltage between the first electrode 104 and the second electrode 102 by use of the power supply 101, and boils the liquid 108 near the opening portion 105 so as to generate the bubble. The elemental analysis device 100 discharges in the bubble so as to generate the plasma 106, and detects the emission spectrum of the plasma 109 by use of the light detection device 109.

### Comparative Example 1

Comparative Example 1 uses the elemental analysis device 300 according to the reference example as shown in FIG. 11. Hereinafter, the detail configuration of Comparative Example 1 is described. In Comparative Example 1, the treatment tank 307 has a volume of about 100 cm³. The treatment tank 307 is made of glass. The first electrode 304 has a cylindrical shape having an inner diameter of 1 mm and an outer diameter of 2 mm. The first electrode 304 is made of tungsten. The insulator 303 is made of quartz having thickness of 1 mm. The insulator 303 is disposed around the circumference surface of the first electrode 304. The second electrode 302 has a cylinder shape having a diameter of 1 mm. The second electrode 302 is made of tungsten. The distance between the first electrode 304 and the second electrode 302 is about 40 mm. The liquid 308 is produced by dissolving NaCl in pure water. The electrical conductivity is adjusted in ranging from 48.5 mS/m to 300 mS/m. The Pump 305 supplies an air from out of the treatment tank 307 at flow rate of 2.0 L/min to generate the bubble 310 in the liquid 308. The power supply 301 supplies an electric power of 300 W, and applies a pulse voltage having a peak voltage of 4 kV, a pulse width of 1 μs, a frequency of 30 kHz to the first electrode 304. The light detection device 309 detects a light having a wavelength in ranging from 300 to 800 nm by use of a commercially available spectroscope. An exposure time is 20 ms. An accompanying optical fiber is attached to the spectroscope, and the optical fiber is disposed at a position which is able to detect the plasma light at the outside of the treatment tank 307.

In Comparative Example 1 having the above configuration, the elemental analysis device 300 generates the bubble 310 by supplying the air from the pump 305 to the first electrode 304. The elemental analysis device 300 applies the pulse voltage between the first electrode 304 and the second electrode 302 by use of the power supply 301 to discharge in the bubble 310 so as to generate the plasma 306. The elemental analysis device 300 detects the emission spectrum of the plasma 306 by use of the light detection device 309.

### [Comparison Result]

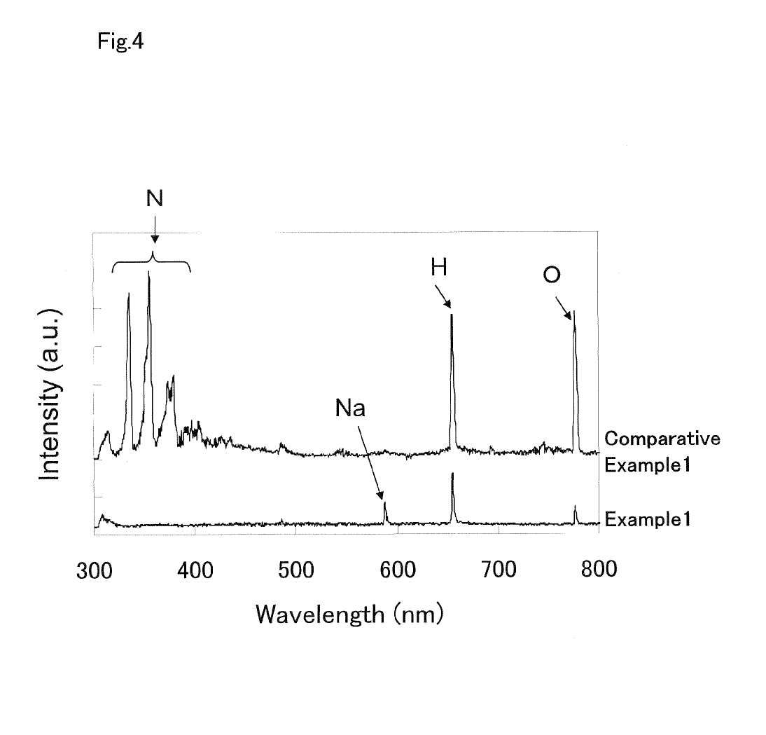

FIG. 4 shows a view of comparing an emission spectrum of Example 1 with an emission spectrum of Comparative Example 1 at electric conductivity of about 50 mS/m. As shown in FIG. 4, in the emission spectrum of Example 1, since a specific peak of Na appears near 589 nm, Na is able to be detected. On the other hand, in the emission spectrum of Comparative Example 1, since the specific peak of Na does not appear near 589 nm, Na is not able to be detected. Therefore, it is found that Na is not able to be detected in the case of Comparative Example 1, while Na is able to be detected in the case of Example 1.

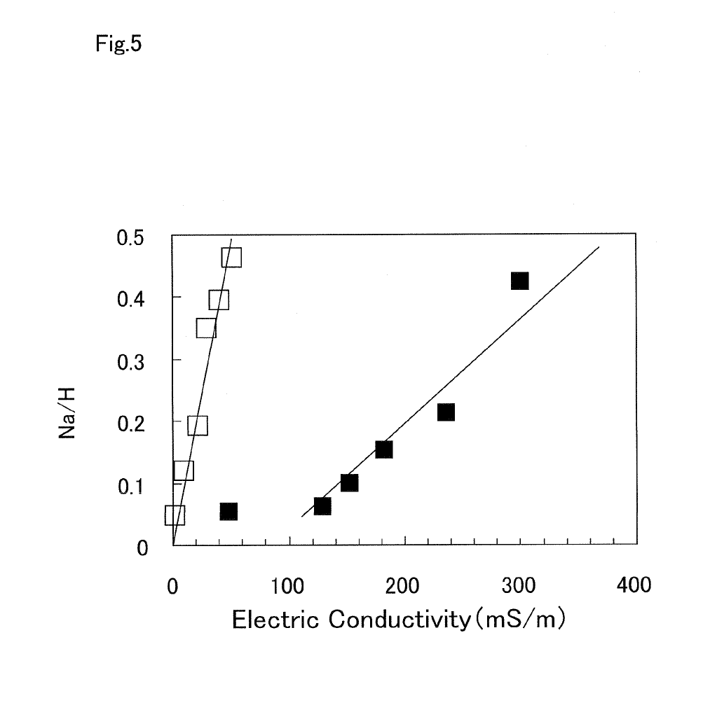

FIG. 5 shows a view of comparing Na/H of Example 1 with Na/H of Comparative Example 1 in the case of electric conductivity in range from 0 to 300 mS/m. In FIG. 5, a white square (□) indicates a plot of the value of the Na/H measured in Example 1, a black square (▪) indicates a plot of the value of the Na/H measured in Comparative Example 1. As shown in FIG. 5, Na/H shows a rising linearity from the electric conductivity of about 0 mS/m in Example 1. That is, in Example 1, a detection sensibility is high, even if the electric conductivity is low. On the other hand, in Comparative Example 1, the value of Na/H does not have change substantially in ranging from the electric conductivity of 0 to 100 mS/m, and shows a rising linearity from the electric conductivity of about 100 mS/m. That is, in Comparative Example 1, a detection sensibility is low in the electric conductivity of less than or equal to 100 mS/m. In Comparative Example 1, in order to obtain a sufficient sensitivity, there is required a pretreatment, such as increasing the electric conductivity of the liquid before performing the elemental analysis.

Example 1 can detect Na in the electric conductivity of less than or equal to 100 mS/m, and can detect with a high sensitivity, as compared with Comparative Example 1. Therefore, the elemental analysis device 100 according to the first embodiment does not need to perform the pretreatment such as increasing the electric conductivity before performing the elemental analysis since Na is able to be detected even if the electric conductivity is low.

Next, in the elemental analysis device 100 according to the first embodiment (Example 2) and the elemental analysis device 300 according to the reference example (Comparative Example 2), there is explained a result of comparing Example 2 with Comparative result 2 when the elemental analysis using commercially available mineral water (hardness 1310) is performed.

### Example 2

Example 2 is different from Example 1 in that the liquid 108 is commercially available mineral water. The configuration of Example 2 is identical to the configuration of Example 1.

### Comparative Example 2

Comparative Example 2 is different from Comparative Example 1 in that the liquid 108 is commercially available mineral water and the gas supplied from the pump 305 is helium. The configuration of Comparative Example 2 is identical to the configuration of Comparative Example 2.

### [Comparison Result]

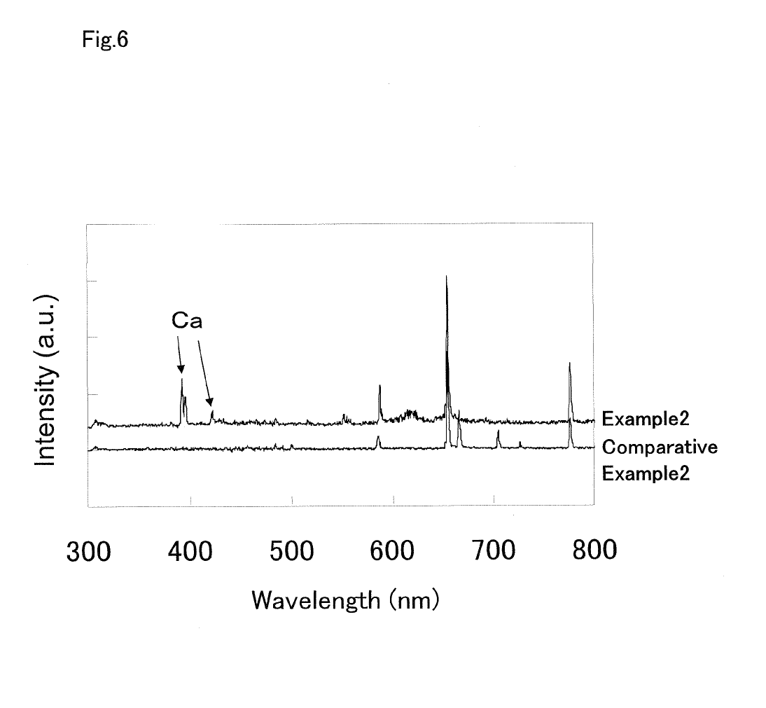

FIG. 6 shows a view of comparing an emission spectrum of Example 2 with an emission spectrum of Comparative Example 2 in a commercial mineral water. In Example 2, Ca is able to be detected because a specific peak of Ca appears near 396.8 nm and 422.7 nm. On the other hand, in Comparative Example 2, Ca is not able to be detected because the specific peak of Ca does not appear near 396.8 nm and 422.7 nm. Therefore, Example 2 can detect Ca with high sensitivity as compared with Comparative Example 2.

As described above, Example 2 can detect Ca with high sensitivity as compared with Comparative Example 2.

In the elemental analysis device 100 according to the first embodiment, the element which is analyzed emits a light having specific wavelength in the plasma 106. In the elemental analysis device 100 according to the first embodiment, both organic and inorganic substances also may be subjected to the analysis. For example, the element which is subjected to the analysis is calcium (Ca), sodium (Na), or potassium (Ka). The analysis using the emission spectrum of the plasma light may be used in both qualitative and quantitative analysis. Therefore, the elemental analysis device 100 according to the first embodiment may be used as a liquid analysis device (for example, water qualify analysis device).

The elemental analysis device 100 according to the first embodiment of the present disclosure may be used in a washing machine, for example. In that case, water hardness is measured by measuring potassium (Ka) concentration or magnesium (Mg) concentration in water. The washing machine using the elemental analysis device 100 may adjust a quantity of a detergent based on the water hardness which is measured. Alternatively, the elemental analysis device 100 according to the first embodiment may be used as a liquid analysis device for managing solution culture for cultivation of plants. More specifically, the elemental analysis device 100 according to the first embodiment may be used for analyzing a quantity of Na and a quantity of Ka in the solution culture for cultivation of plants.

As described above, the elemental analysis device 100 according to the first embodiment may have a simple device configuration as compared with the conventional device. The elemental analysis device 100 according to the first embodiment can discharge stably near the opening portion 105 even if the gas supply device (the pump) 305 is not used as in the elemental analysis device 300 of the reference example. As a result of that, the elemental analysis device 100 according to the first embodiment can generate the plasma 106 efficiently.

In the elemental analysis device 100 according to the first embodiment, the power supply 101 applies the voltage between the first electrode 104 and the second electrode 102. By vaporizing the liquid 108, the bubble is generated near the opening portion 105. Therefore, in the first embodiment, because the bubble does not contain an atmospheric air, the plasma 106 is easy to contact with the element in the liquid 108, and the plasma light can be detected with high sensitivity.

As described above, according to the elemental analysis device according to the first embodiment, the elemental analysis can be performed without performing the pretreatment for increasing the electric conductivity of the liquid 108 as in the conventional device, because the element can be detected even if the electric conductivity of the liquid 108 is low.

The treatment tank 107 in the first embodiment may have the configuration which at least a part is optically transparent. With this configuration, the light detection device 109 disposed out of the treatment tank 107 may detect efficiently the plasma light which is generated at the opening port 105 of the insulator 103.

The opening portion in the first embodiment may have a diameter of less than or equal to 1 mm. With this configuration, the electric field concentration can be generated at the opening portion 105 of the insulator 103 and then it can be reliably discharged. Especially, in the case that the opening portion has the diameter in ranging from 0.3 to 0.5 mm, the elemental analysis device 100 can discharge stably near the opening portion 105, and can generate the stable plasma 106 efficiently.

The light detection device 109 in the first embodiment may detect the plasma light spreading to the liquid 108 of the plasma 106 generated near the opening portion 105. Therefore, the light detection device 109 can detect the plasma light at the part where the interaction of the liquid 108 with the plasma 106 is strong in particular. As a result of this, the detection sensitivity of the plasma light derived from the element can be improved.

The insulator 103 may prevent from absorbing the plasma light, because the insulator 103 is made of an optically transparent material. Therefore, the elemental analysis device 100 can detect the plasma light efficiently. In particular, when the insulator 103 is made of quartz, it is possible to provide the elemental analysis device capable of preventing from absorbing the light in ultraviolet region and having high resistance to plasma.

The influence of the light emission derived from the first electrode 104 may be suppressed or reduced because the first electrode 104 in the first embodiment is made of tungsten. Therefore, the detection sensitivity of the plasma light derived from the element in the liquid 108 can be improved.

The power supply 101 in the first element may supplies the pulse voltage having the peak voltage of more than equal to 4 kV. Therefore, the discharge is generated by concentrating the electric field near the opening portion 105 of the insulator 103, and the plasma can be generated efficiently.

### Second Embodiment

In a second embodiment of the present disclosure, an elemental analysis device 200 is configured to remove the treatment tank 107 from the configuration of the first embodiment. There is explained about the elemental analysis device 200 having a module which is formed by the components of the first embodiment except for the treatment tank 107.

### [Overall Configuration]

The configuration of the elemental analysis device 200 according to the second embodiment of the present disclosure is explained.

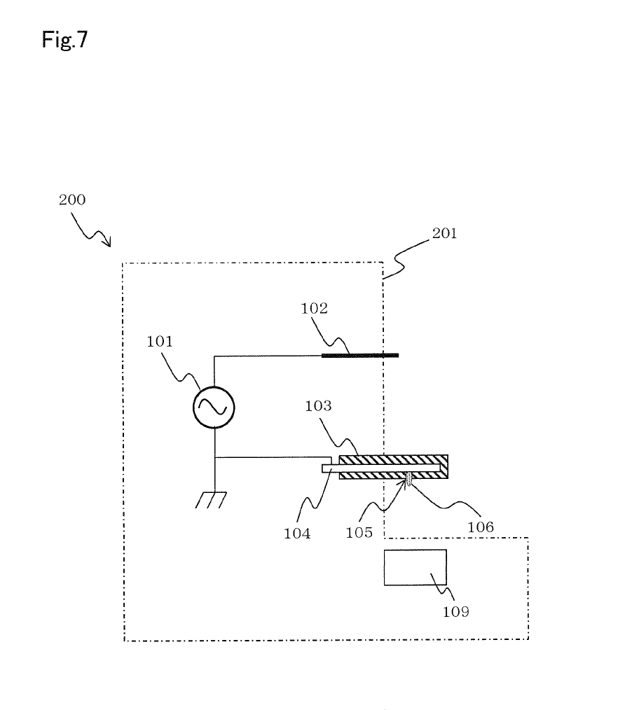

FIG. 7 shows an overall block diagram of the elemental analysis device 200 according to the second embodiment of the present disclosure. As shown in FIG. 7, the second embodiment is different from the first embodiment in that a module 201 is formed by the components of the first embodiment except for the treatment tank 107. The module 201 includes the first electrode 104, the second electrode 102, and the insulator 103. The module 201 may also include the power supply 101 and/or the light detection device 109. In the second embodiment, the other configuration is identical to the configuration of the first embodiment. When explained more specifically, in the first embodiment, the elemental analysis 100 is configured that at least a part of the first electrode 104 which generates the plasma 106 and at least a part of the second electrode 102 are disposed in the treatment tank 107. On the other hand, in the second embodiment, it is not necessary that a part of the first electrode 104 and the second electrode 102 are disposed in the treatment tank 107. For example, the elemental analysis device 200 in the second embodiment may analyze the element in the liquid by immersing the module 201 having the plasma 106 generating component (for example, the first electrode 104, the second electrode 102, the insulator 103, the power supply 101) and the plasma light detecting component (for example, the light detection device 109) into the liquid. Hereinafter, in the explanation of the second embodiment, there is explained about the elemental analysis device 200 having the module 201 which is formed by the first electrode 104, the second electrode 102, the insulator 103, the power supply 101, and the light detection device 109.

As shown in FIG. 7, in the elemental analysis device 200 according to the second embodiment, the module 201 is formed by the components in the area shown by the dashed line. For example, the module 201 includes the first electrode 104, the second electrode 102, the insulator 103, the power supply 101, and the light detection device 109. The part of the first electrode 104, the part of the second electrode 102, and the part of the insulator 103 are disposed outside of the module 201. At the insulator 103, the opening portion 105 is arranged. The opening portion 105 is arranged outside of the module 201 so as to expose the part of the first electrode 104. Except for the part that is disposed outside of the above described module 201, these components are made waterproof. Alternatively, except for the part that is disposed outside of the above described module 201, these components are disposed in a housing which is made waterproof. The waterproof may be made by a well known method in the general. In the second embodiment, the elemental analysis device 200 is configured to immerse the part of the first electrode 104 and the part of the second electrode 102 into the liquid 202 and contact the liquid 202 by putting the module 201 which is made waterproof into the liquid 202.

### [Operation]

An operation of the elemental analysis device 200 according to the second embodiment of the present disclosure is explained.

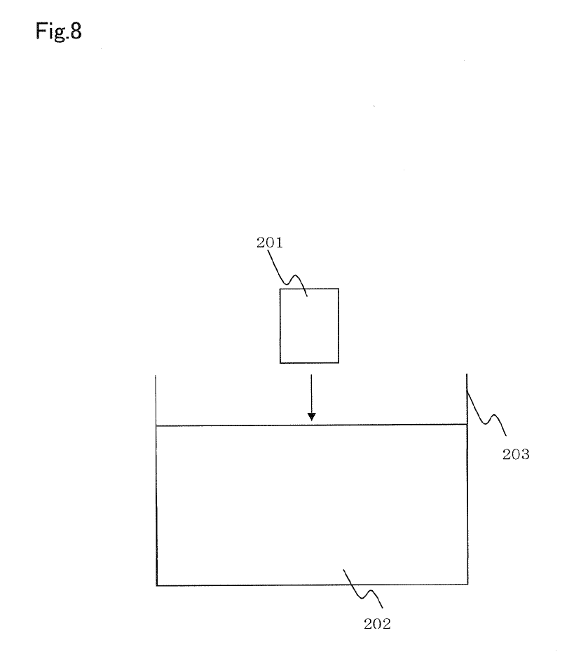

FIG. 8 shows a view of a usage example of the elemental analysis device 200 according to the second embodiment of the present disclosure. As shown in FIG. 8, when the module 201 in the second embodiment puts into a vessel 203 containing the liquid 202, the part of the first electrode 104 and the part of the second electrode 102 are immersed in and are contacted the liquid 202. Each component in the module 201 according to the second embodiment is operable even if the part of the first electrode 104 and the part of the second electrode 102 are immersed in the liquid 202, because the components are made waterproof as above described.

Next, the elemental analysis device 200 applies a voltage between the first electrode 104 and the second electrode 102 by use of the power supply 101. The elemental analysis device 200 boils the liquid 202 near the opening portion 105 arranged at the insulator 103, and generates the bubble by applying the voltage between the first electrode 104 and the second electrode 102. The elemental analysis device 200 generates the plasma 106 by discharging in the bubble. In the bubble generated, the light emission derived from the element is generated by contacting the element in the liquid 202 with the plasma 106. The element in the liquid 202 may be analyzed by detecting this light emission by use of the light detection device 109.

### [Effect]

An effect of the elemental analysis device 200 according to the second embodiment is explained.

In the elemental analysis device 200 according to the second embodiment, the module 201 is formed by the plasma generating component and the plasma light detecting component. Therefore, according to the second embodiment, there may be provided the elemental analysis device having good portability.

Because the module 201 in the second embodiment is made waterproof, each component is operable even if the module 201 is put into the liquid 202.

According to the second embodiment, the module 201 may be moved in the liquid 202, for example. Therefore, multiple elemental analyses can be performed by changing a depth or a location where generates the plasma 106. As a result, it can be easily perform a mapping of impurities included in the liquid 202.

In the second embodiment, there is explained about the configuration that the liquid 202 puts into the vessel 203, however, the vessel 203 is not necessary component. For example, when it is desired to measure water quality of river, the water quality may be measured by immersing the module 201 according to the second embodiment into the river.

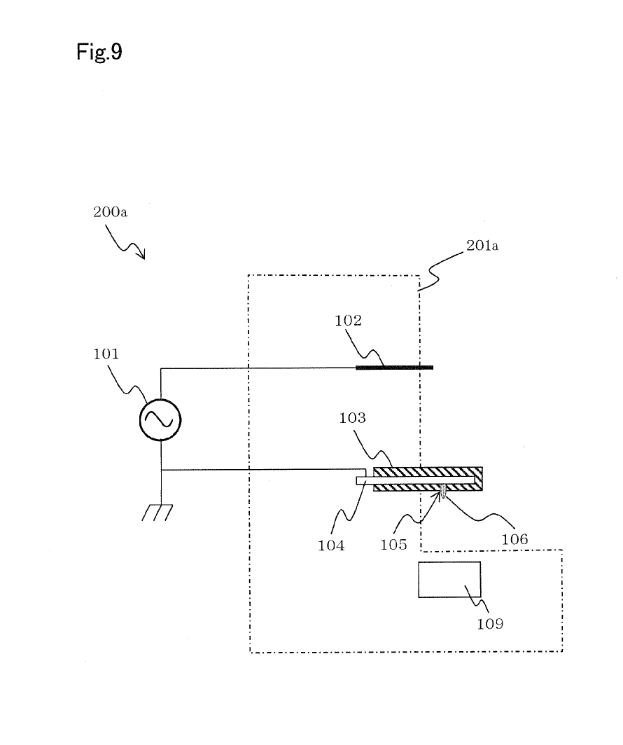

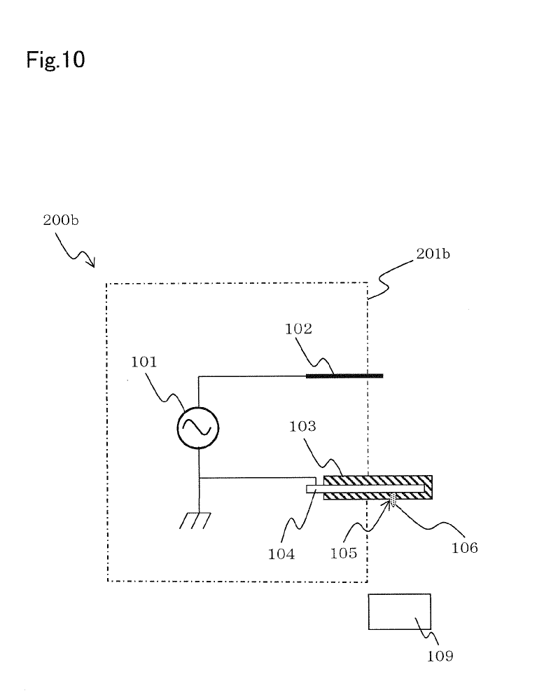

As a variation of the second embodiment, the element analysis device may be configured to dispose one or more component outside of the module 201, except for the part of the first electrode 104, the part of the second electrode 102, and the part of the insulator 103. For example, as shown in FIG. 9, a variation of an elemental analysis device 200a may be configured to dispose the pulse power supply 101 outside of the module 201a. That is, the variation of the elemental analysis device 200a may be configured that the pulse power supply 101 is not contained in the module 201a. In this case, the elemental analysis device 200a does not put the power supply 101 into the liquid. The power supply 101 may be connected with the first electrode 104 and the second electrode 102 through a cable which is made waterproof. As shown in FIG. 10, another variation of an elemental analysis device 200b may be configured to dispose the light detection device 109 outside of a module 201b. Alternatively, as another variation, an elemental analysis device may be configured to dispose all components outside of the module 201, except for the first electrode 104, the second electrode 102, and the insulator 103.

The elemental analysis device according to the present disclosure is capable of performing the elemental analysis with high sensitivity. For example, it can be used for water quality management of water supply and sewerage, effluent management in a factory, or concentration control of nourishing solution used in an agriculture or cultivation of flowers. In addition, the elemental analysis device according to another embodiment of the present disclosure has good portability and capable of performing the elemental analysis at variable locations. For example, the elemental analysis device according to the present disclosure can analyze a water quality easily.

1. An elemental analysis device comprising:
a first electrode having a part disposed in a treatment tank into which a liquid is filled;
a second electrode having a part disposed in the treatment tank;
an insulator disposed around the first electrode, wherein the insulator has an opening portion which is arranged to expose the part of the first electrode;
a power supply that applies a voltage between the first electrode and the second electrode; and
a light detection device that detects an emission spectrum of plasma which is generated by applying the voltage by use of the power supply so as to discharge near the opening portion;
wherein an element included in the liquid is analyzed based on the emission spectrum which is detected by the light detection device.

2. The elemental analysis device according to claim 1 further comprising a treatment tank in which the first and the second electrodes are disposed,
wherein at least a part of the treatment tank is optically transparent.

3. The elemental analysis device according to claim 1, wherein the opening portion has a diameter of less than or equal to 1 mm.

4. The elemental analysis device according to claim 1, wherein the light detection device detects plasma light spreading to the liquid side of the plasma which is generated near the opening portion.

5. The elemental analysis device according to claim 1, wherein the insulator is optically transparent.

6. The elemental analysis device according to claim 5, wherein the insulator includes quartz.

7. The elemental analysis device according to claim 1, wherein the first electrode is made of tungsten.

8. The elemental analysis device according to claim 1, wherein the power supply applies a pulse voltage having a peak voltage of more than or equal to 4 kV.

9. An elemental analysis device comprising:
a first electrode;
a second electrode;
an insulator disposed around the first electrode, wherein the insulator has an opening portion which is arranged to expose a part of the first electrode;
a power supply that applies a voltage between the first electrode and the second electrode; and
a light detection device that detects an emission spectrum of plasma which is generated by applying the voltage by use of the power supply so as to discharge near the opening portion;
wherein a module is formed by the first electrode, the second electrode, and the insulator,
the module is disposed in a liquid,
plasma is generated near the opening portion by applying the voltage between the first electrode and the second electrode by use of the power supply, and an element included in the liquid is analyzed based on the emission spectrum of the plasma which is detected by the light detection device.

10. The elemental analysis device according to claim 9, wherein the module further including the power supply.

11. The elemental analysis device according to claim 9, wherein the module further including the light detection device.

12. The elemental analysis device according to claim 9, wherein the module is waterproofed.

13. The elemental analysis device according to claim 9, wherein the opening portion has a diameter of less than or equal to 1 mm.

14. The elemental analysis device according to claim 9, wherein the light detection device detects plasma light spreading to the liquid side of the plasma which is generated near the opening portion.

15. The elemental analysis device according to claim 9, wherein the insulator is optically transparent.

16. The elemental analysis device according to claim 15, wherein the insulator includes quartz.

17. The elemental analysis device according to claim 9, wherein the first electrode is made of tungsten.

18. The elemental analysis device according to claim 9, wherein the power supply applies a pulse voltage having a peak voltage of more than or equal to 4 kV.
